(19) United States
(12) Patent Application Publication
(10) Pub. No.: US 2021/0352972 A1
(43) Pub. Date: Nov. 18, 2021

(54) COMBINATION PONCHO AND EMERGENCY BLANKET AND ASSOCIATED METHODS

(71) Applicant: James Isbell, Jacksonville, FL (US)

(72) Inventor: James Isbell, Jacksonville, FL (US)

(21) Appl. No.: 16/876,026

(22) Filed: May 16, 2020

(51) Int. Cl. A41D 3/00; A41D 31/10

(52) U.S. Cl. CPC A41D 3/005; A41D 31/10

(57) ABSTRACT

A combination poncho and emergency blanket includes a body consisting of (or alternatively including) a flexible sheet consisting of (or alternatively including) a first outer layer and a second outer layer directly attached to the first outer layer. Such a first outer layer is a front face of the body and the second outer layer is a rear face of the body. Advantageously, the first outer layer includes a biaxially oriented polyethylene terephthalate resin. Advantageously, the second outer layer includes an aluminized biaxially oriented polyethylene terephthalate resin; wherein the first outer layer and the second outer layer have a combined cross-sectional thickness of 24 microns.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND

### Technical Field

Exemplary embodiment(s) of the present disclosure relate to ponchos and, more particularly, to a combination poncho and emergency blanket including a biaxially oriented polyethylene terephthalate resin layer, and an aluminized biaxially oriented polyethylene terephthalate resin layer having a combined cross-sectional thickness of 24 microns for minimizing handling weight while maximizing tear resistance and thermal-insulating properties.

### Prior Art

It is important that outdoorsman have equipment to stay safe and protected while pursuing their activities. Typically, these outdoorsman may be exposed to potentially dangerous weather conditions or situations while pursuing their activities. Having multifunctional items such as a combination poncho and emergency blanket saves precious space and gives these outdoorsmen additional critical capabilities that they may not otherwise have. The combination poncho and emergency blanket not only serves as a wearable poncho and emergency blanket but can also be turned inside out to expose its highly reflective material for increased visibility and reflection during an emergency situation.

Accordingly, a need remains for a combination poncho and emergency blanket in order to overcome at least one aforementioned shortcoming. The exemplary embodiment(s) satisfy such a need by providing body heat retention as well as protects the wearer from poor weather conditions while providing high viability emergency signaling if lost in a strange venue.

### BRIEF SUMMARY OF NON-LIMITING EXEMPLARY EMBODIMENT(S) OF THE PRESENT DISCLOSURE

In view of the foregoing background, it is therefore an object of the non-limiting exemplary embodiment(s) to provide a combination poncho and emergency blanket including a biaxially oriented polyethylene terephthalate resin layer, and an aluminized biaxially oriented polyethylene terephthalate resin layer having a combined cross-sectional thickness of 24 microns for minimizing handling weight while maximizing tear resistance and thermal-insulating properties. These and other objects, features, and advantages of the non-limiting exemplary embodiment(s) are provided by a combination poncho and emergency blanket including a body consisting of (or alternatively including) a flexible sheet consisting of (or alternatively including) a first outer layer and a second outer layer directly attached to the first outer layer. Such a first outer layer is a front face of the body and the second outer layer is a rear face of the body. Notably, the first aperture located at a top first side of the body and configured to receive a user head therethrough. A second aperture is located at a lateral second side of the body and configured to receive a user first arm therethrough. A third aperture is located at a lateral third side of the body and configured to receive a user second arm therethrough. A hood is statically connected to the first aperture. Advantageously, the first outer layer includes a biaxially oriented polyethylene terephthalate resin. Advantageously, the second outer layer includes an aluminized biaxially oriented polyethylene terephthalate resin; wherein the first outer layer and the second outer layer have a combined cross-sectional thickness of 24 microns.

In a non-limiting exemplary embodiment, the biaxially oriented polyethylene terephthalate resin is transparent.

In a non-limiting exemplary embodiment, the biaxially oriented polyethylene terephthalate resin is opaque and contains a color pigment.

In a non-limiting exemplary embodiment, the aluminized biaxially oriented polyethylene terephthalate resin has a reflective metallic surface.

In a non-limiting exemplary embodiment, each of the biaxially oriented polyethylene terephthalate resin and the aluminized biaxially oriented polyethylene terephthalate resin has a respective thickness equal to 12 microns.

In a non-limiting exemplary embodiment, the biaxially oriented polyethylene terephthalate resin is directly and thermally bonded to the aluminized biaxially oriented polyethylene terephthalate resin.

In a non-limiting exemplary embodiment, each of the first outer layer and the second outer layer has a uniform cross-sectional thickness throughout an entire surface area thereof, respectively.

In a non-limiting exemplary embodiment, the second aperture is coextensively shaped as the third aperture.

In a non-limiting exemplary embodiment, the first aperture is medially and equidistantly disposed between the second aperture and the third aperture.

The present disclosure further includes a method of utilizing a combination poncho and emergency blanket. Such a method includes the initial step of: providing a body consisting of (or alternatively including): a flexible sheet consisting of (or alternatively including) a first outer layer and a second outer layer directly attached to the first outer layer, wherein the first outer layer is a front face of the body and the second outer layer is a rear face of the body, a first aperture located at a top first side of the body and configured to receive a user head therethrough, a second aperture located at a lateral second side of the body and configured to receive a user first arm therethrough, a third aperture located at a lateral third side of the body and configured to receive a user second arm therethrough, and a hood statically connected to the first aperture, wherein the first outer layer includes a biaxially oriented polyethylene terephthalate resin, wherein the second outer layer includes an aluminized biaxially oriented polyethylene terephthalate resin, and wherein the first outer layer and the second outer layer have a combined cross-sectional thickness of 24 microns. The method further includes the step of: a user wearing the body over an upper region of the user.

There has thus been outlined, rather broadly, the more important features of non-limiting exemplary embodiment(s) of the present disclosure so that the following detailed description may be better understood, and that the present contribution to the relevant art(s) may be better appreciated. There are additional features of the non-limiting exemplary embodiment(s) of the present disclosure that will be described hereinafter and which will form the subject matter of the claims appended hereto.

### BRIEF DESCRIPTION OF THE NON-LIMITING EXEMPLARY DRAWINGS

The novel features believed to be characteristic of non-limiting exemplary embodiment(s) of the present disclosure are set forth with particularity in the appended claims. The non-limiting exemplary embodiment(s) of the present disclosure itself, however, both as to its organization and method of operation, together with further objects and advantages thereof, may best be understood by reference to the following description taken in connection with the accompanying drawings in which:

FIG. 1 is an environmental front elevational view of a combination poncho and emergency blanket, in accordance with a non-limiting exemplary embodiment of the present disclosure;

FIG. 2 is an environmental right-side elevational view of a combination poncho and emergency blanket, in accordance with a non-limiting exemplary embodiment of the present disclosure;

FIG. 2a is an environmental left-side elevational view of a combination poncho and emergency blanket, in accordance with a non-limiting exemplary embodiment of the present disclosure;

FIG. 3 is an environmental perspective view of a combination poncho and emergency blanket turned inside-out, in accordance with a non-limiting exemplary embodiment of the present disclosure;

FIG. 4 is an environmental front-elevational view of a combination poncho and emergency blanket worn over a backpack, in accordance with a non-limiting exemplary embodiment of the present disclosure;

FIG. 4a is an environmental left-side elevational view of the combination poncho and emergency blanket shown in FIG. 4; and

FIG. 5 is an enlarged cross-sectional view of the body taken along line 5-5 in FIG. 1.

Those skilled in the art will appreciate that the figures are not intended to be drawn to any particular scale; nor are the figures intended to illustrate every non-limiting exemplary embodiment(s) of the present disclosure. The present disclosure is not limited to any particular non-limiting exemplary embodiment(s) depicted in the figures nor the shapes, relative sizes or proportions shown in the figures.

### DETAILED DESCRIPTION OF NON-LIMITING EXEMPLARY EMBODIMENT(S) OF THE PRESENT DISCLOSURE

The present disclosure will now be described more fully hereinafter with reference to the accompanying drawings, in which non-limiting exemplary embodiment(s) of the present disclosure is shown. The present disclosure may, however, be embodied in many different forms and should not be construed as limited to the non-limiting exemplary embodiment(s) set forth herein. Rather, such non-limiting exemplary embodiment(s) are provided so that this application will be thorough and complete and will fully convey the true spirit and scope of the present disclosure to those skilled in the relevant art(s). Like numbers refer to like elements throughout the figures.

The illustrations of the non-limiting exemplary embodiment(s) described herein are intended to provide a general understanding of the structure of the present disclosure. The illustrations are not intended to serve as a complete description of all of the elements and features of the structures, systems and/or methods described herein. Other non-limiting exemplary embodiment(s) may be apparent to those of ordinary skill in the relevant art(s) upon reviewing the disclosure. Other non-limiting exemplary embodiment(s) may be utilized and derived from the disclosure such that structural, logical substitutions and changes may be made without departing from the true spirit and scope of the present disclosure. Additionally, the illustrations are merely representational are to be regarded as illustrative rather than restrictive.

One or more embodiment(s) of the disclosure may be referred to herein, individually and/or collectively, by the term “non-limiting exemplary embodiment(s)” merely for convenience and without intending to voluntarily limit the true spirit and scope of this application to any particular non-limiting exemplary embodiment(s) or inventive concept. Moreover, although specific embodiment(s) have been illustrated and described herein, it should be appreciated that any subsequent arrangement designed to achieve the same or similar purpose may be substituted for the specific embodiment(s) shown. This disclosure is intended to cover any and all subsequent adaptations or variations of other embodiment(s). Combinations of the above embodiment(s), and other embodiment(s) not specifically described herein, will be apparent to those of skill in the relevant art(s) upon reviewing the description.

References in the specification to “one embodiment(s)”, “an embodiment(s)”, “a preferred embodiment(s)”, “an alternative embodiment(s)” and similar phrases mean that a particular feature, structure, or characteristic described in connection with the embodiment(s) is included in at least an embodiment(s) of the non-limiting exemplary embodiment(s). The appearances of the phrase “non-limiting exemplary embodiment” in various places in the specification are not necessarily all meant to refer to the same embodiment(s).

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiment(s) and are not necessarily intended to be construed as limiting.

If used herein, “about” means approximately or nearly and in the context of a numerical value or range set forth means±15% of the numerical.

If used herein, “substantially” means largely if not wholly that which is specified but so close that the difference is insignificant.

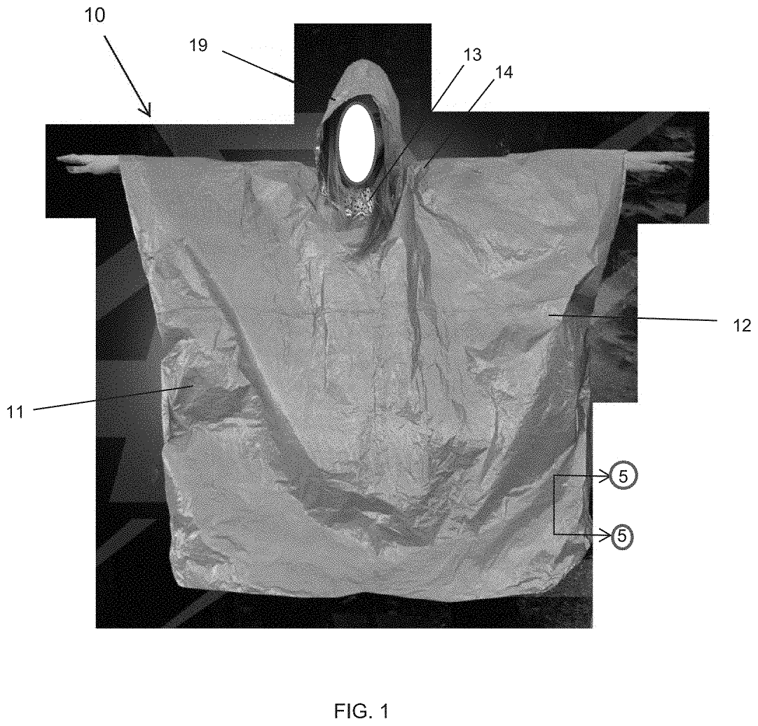

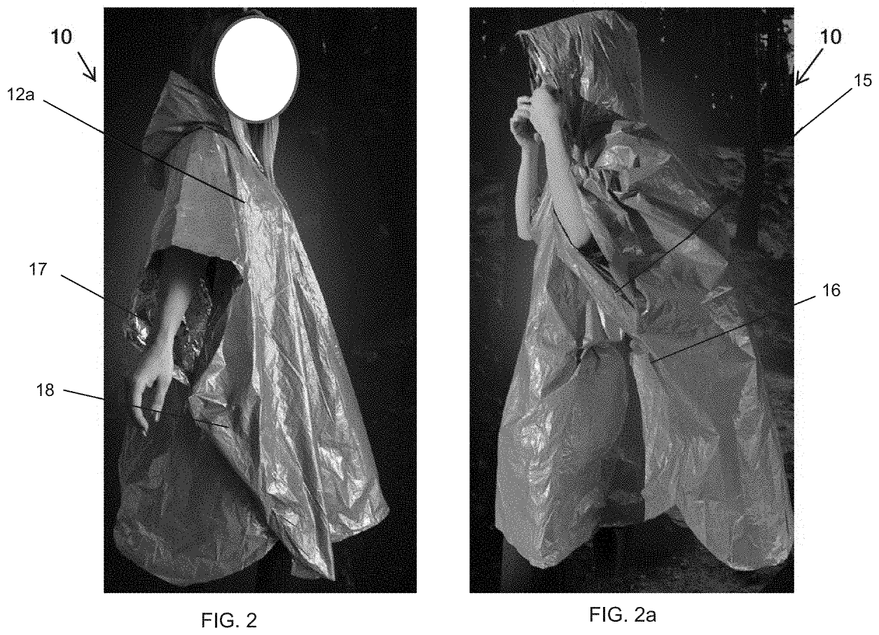

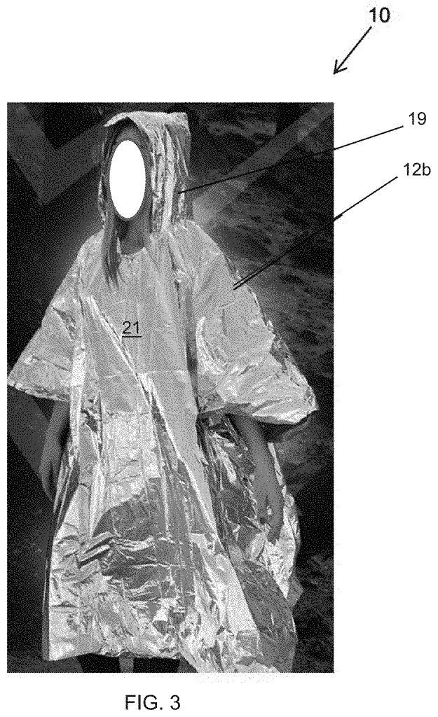

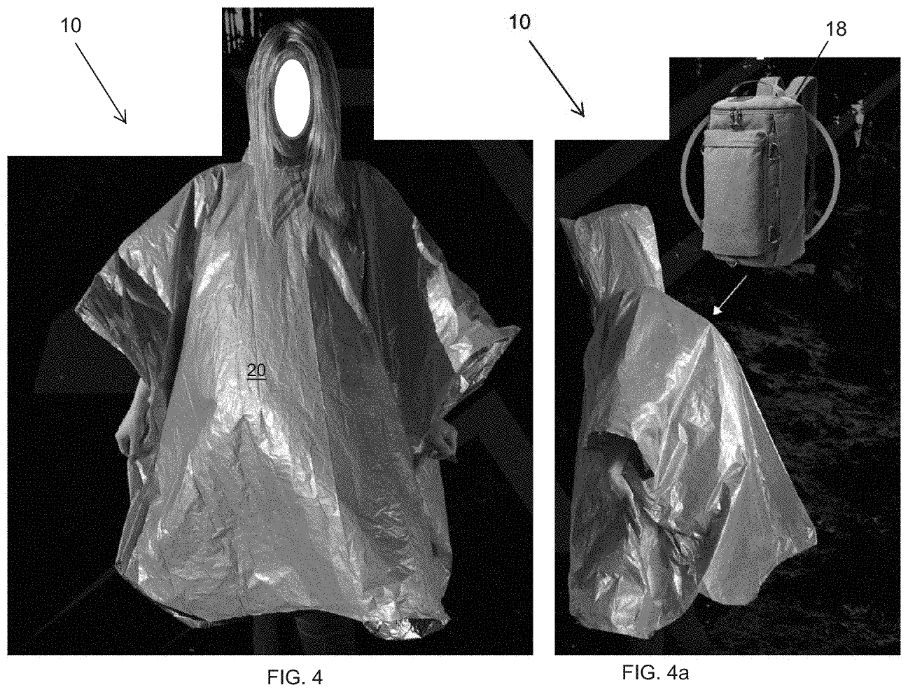

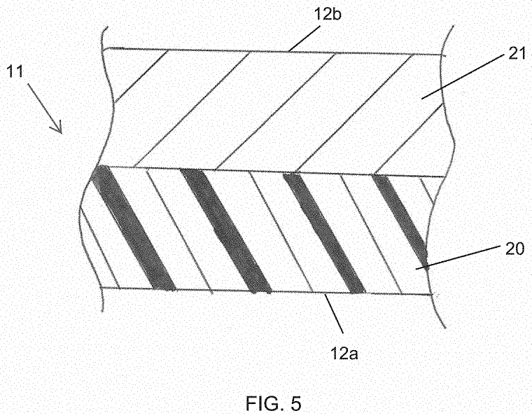

The non-limiting exemplary embodiment(s) is/are referred to generally in FIGS. 1-5 and are intended to provide a combination poncho and emergency blanket 10 including a biaxially oriented polyethylene terephthalate resin layer 20, and an aluminized biaxially oriented polyethylene terephthalate resin layer 21 having a combined cross-sectional thickness of 24 microns for minimizing handling weight while maximizing tear resistance and thermal-insulating properties. It should be understood that the exemplary embodiment(s) may be used at a variety of parties and should not be limited to any particular party described herein.

Advantageously, different materials were tested using a digital micrometer which is an electronic gauge tool that measures the thickness of materials. Next, a poncho was made out of an aluminized biaxially oriented polyethylene terephthalate resin layer 21 and a biaxially oriented polyethylene terephthalate resin layer 20, having a combined thickness of between 10 and 12 microns. Such a thickness tended to rip and tear easily at both the 10 microns and 12 microns thicknesses, respectively. Thus, the thickness was incrementally increased by 2 microns and tested until 18 microns was reached. At 18 microns thick, the material began to initially endure the rip and tear test, but would still rip and tear after moderate pressure increases. The thickness was again incrementally increased up to the 36 microns. While at 36 microns the material had considerable strength, the production of the final product (combined poncho and blanket) began to suffer due to the increased thickness (bulkiness) of the sheet 12 of material and the manufacturing equipment's inability to handle such a large thickness. Also, the weight increased significantly and hindered the objective of providing a lightweight and portable combined poncho and blanket. Thus, the thickness was incrementally decreased until the perfect level of 24 microns was found, which met the objectives of having considerable sheer strength and tensile strength as well as maintaining the ability to be efficiently handled as a roll of a continuous sheet 12 that can be easily cut, sized, and shaped during the manufacturing process. Such a 24 microns thickness has a structure that is critical for providing the new, useful, and unpredictable result of maintaining considerable endurance as well as maintaining the ability to be manufactured efficiently.

In a non-limiting exemplary embodiment, body 11 includes at least one layer made of a biaxially oriented polyethylene terephthalate (BoPET) resin 20 for durability and tear resistance. BoPET is a polyester film made from stretched polyethylene terephthalate and is used for its high tensile strength, chemical and dimensional stability, transparency, reflectivity, gas and aroma barrier properties, and electrical insulation. The flexible, single and unitary sheet 12 is made reflective or metalized by sputtering a thin layer of metal onto its surfaces. Like aluminum foil, the reflective sheet 12 has one shiny side and one dull side. This type of sheet 12 is less permeable to gasses and reflects up to 99 percent of light, which is effective for insulation. It is also waterproof and windproof. The waterproof quality means that sheet 12 can prevent heat loss from evaporation, and helps the user stay warm and retain body heat during intense sweating because of evaporation.

In a non-limiting exemplary embodiment, the sheet 12 also has a shiny surface because aluminum foil is applied thereto as an outside material. Aluminum BoPET is made from refined aluminum. To produce the sheet 12 covered with aluminum BoPET layer 21, the polyester resin (BoPET) is melted and then stretched into an extremely thin and flat layer. The refined aluminum layer is melted as a way of removing the aluminum oxide. Next, the aluminum oxide is reduced electrolytically in a mixture of molten cryolite to eliminate any oxygen from the metal. The heated aluminum is then flattened into a very thin layer. Then, the heated aluminum layer is thermally bonded to the BoPET layer 20 to form the aluminum BoPET layer 21. As noted above, the preferred combined thickness of the BoPET 20 layer and aluminum BoPET layer 21 is about 24 microns.

In a non-limiting exemplary embodiment, the body 11 may contain an aluminum BoPET layer 21 and a BoPET (non-aluminum) layer 20 thermally bonded together, wherein the BoPET layer 20 is transparent. The aluminum BoPET layer 21 has a cross-sectional thickness equal to a cross-sectional thickness of the BoPET layer 20 (e.g., 12 microns each).

In a non-limiting exemplary embodiment, the body 11 may contain an aluminum BoPET layer 21 and a BoPET (non-aluminum) layer 20 thermally bonded together, wherein the BoPET layer 20 is opaque and contains a color pigmentation (e.g., orange, yellow, camouflage). The aluminum BoPET layer 21 has a cross-sectional thickness equal to a cross-sectional thickness of the BoPET layer (e.g., 12 microns each).

In a non-limiting exemplary embodiment, the body 11 may contain an aluminum BoPET layer 21 and a BoPET (non-aluminum) layer 20 thermally bonded together. The BoPET layer 20 is opaque and contains a color pigmentation (e.g., orange, yellow, camouflage). The aluminum BoPET layer 21 has a cross-sectional thickness (e.g., 16 microns) greater than a cross-sectional thickness of the BoPET layer 20 (e.g., 8 microns).

In a non-limiting exemplary embodiment, the body 11 is 24 microns thick. Such a structural configuration provides the new, useful, and unexpected result of providing improved tear resistant, while being suitably light-weight for making it easier to shape and handle during manufacturing. This thickness was arrived at after testing and discovering that the combination poncho and emergency blanket 10 at 12 microns thick would tear by hand tearing. However, when the thickness of the combination poncho and emergency blanket 10 was carefully increased to 24 microns, the combination poncho and emergency blanket 10 was unexpectedly found to not tear by hand.

Referring to FIGS. 1-5, in a non-limiting exemplary embodiment, the combination poncho and emergency blanket (collectively at 10) includes a body 11 consisting of (or alternatively including) a flexible sheet 12 consisting of (or alternatively including) a first outer layer 12a and a second outer layer 12b directly attached to the first outer layer 12a. Such a first outer layer 12a is a front face of the body 11 and the second outer layer 12b is a rear face of the body 11. Notably, the first aperture 13 is located at a top first side 14 of the body 11 and configured to receive a user head therethrough. A second aperture 15 is located at a lateral second side 16 of the body 11 and configured to receive a user first arm therethrough. A third aperture 17 is located at a lateral third side 18 of the body 11 and configured to receive a user second arm therethrough. A hood 19 is statically connected to the first aperture 13. Advantageously, the first outer layer 12a includes a biaxially oriented polyethylene terephthalate resin 20. Advantageously, the second outer layer 12b includes an aluminized biaxially oriented polyethylene terephthalate resin 21. Advantageously, the first outer layer 12a and the second outer layer 12b have a combined cross-sectional thickness of 24 microns. Such a structural configuration provides the new, useful, and unexpected result of providing a combination poncho and emergency blanket 10 having considerable sheer strength and tensile strength as well as maintaining the ability to be efficiently handled as a roll of a continuous sheet 12 that can be easily cut, sized, and shaped during the manufacturing process.

In a non-limiting exemplary embodiment, the biaxially oriented polyethylene terephthalate resin 20 is transparent.

In a non-limiting exemplary embodiment, the biaxially oriented polyethylene terephthalate resin 20 is opaque and contains a color pigment (e.g., orange, camouflage, etc.).

In a non-limiting exemplary embodiment, the aluminized biaxially oriented polyethylene terephthalate resin 21 has a reflective metallic surface.

In a non-limiting exemplary embodiment, each of the biaxially oriented polyethylene terephthalate resin 20 and the aluminized biaxially oriented polyethylene terephthalate resin 21 has a respective thickness equal to 12 microns. Such a structural configuration provides the new, useful, and unexpected result of providing a combination poncho and emergency blanket 10 having considerable sheer strength and tensile strength as well as maintaining the ability to be efficiently handled as a roll of a continuous sheet 12 that can be easily cut, sized, and shaped during the manufacturing process.

In a non-limiting exemplary embodiment, the biaxially oriented polyethylene terephthalate resin 20 is directly and thermally bonded to the aluminized biaxially oriented polyethylene terephthalate resin 21. Such a structural configuration provides the new, useful, and unexpected result of providing a combination poncho and emergency blanket 10 having considerable sheer strength and tensile strength as well as maintaining the ability to be efficiently handled as a roll of a continuous sheet 12 that can be easily cut, sized, and shaped during the manufacturing process.

In a non-limiting exemplary embodiment, each of the first outer layer 12a and the second outer layer 12b has a uniform cross-sectional thickness throughout an entire surface area thereof, respectively. Such a structural configuration provides the new, useful, and unexpected result of providing a combination poncho and emergency blanket 10 having considerable sheer strength and tensile strength as well as maintaining the ability to be efficiently handled as a roll of a continuous sheet 12 that can be easily cut, sized, and shaped during the manufacturing process.

In a non-limiting exemplary embodiment, the second aperture 15 is coextensively shaped as the third aperture 17.

In a non-limiting exemplary embodiment, the first aperture 13 is medially and equidistantly disposed between the second aperture 15 and the third aperture 17.

The present disclosure further includes a method of utilizing a combination poncho and emergency blanket 10. Such a method includes the initial step of: providing a body 11 consisting of (or alternatively including): a flexible sheet 12 consisting of (or alternatively including) a first outer layer 12a and a second outer layer 12b directly attached to the first outer layer 12a, wherein the first outer layer 12a is a front face of the body 11 and the second outer layer 12b is a rear face of the body 11, a first aperture 13 is located at a top first side 14 of the body 11 and configured to receive a user head therethrough, a second aperture 15 located at a lateral second side 16 of the body 11 and configured to receive a user first arm therethrough, a third aperture 17 located at a lateral third side 18 of the body 11 and configured to receive a user second arm therethrough, and a hood 19 statically connected to the first aperture 13, wherein the first outer layer 12a includes a biaxially oriented polyethylene terephthalate resin 20, wherein the second outer layer 12b includes an aluminized biaxially oriented polyethylene terephthalate resin 21, and wherein the first outer layer 12a and the second outer layer 12b have a combined cross-sectional thickness of 24 microns. The method further includes the step of: a user wearing the body 11 over an upper region of the user.

In a non-limiting exemplary embodiment, wherein the body 11 is suitably sized and shaped as a one size fits all.

In a non-limiting exemplary embodiment, where the body 11 is configured to entirely cover a backpack 18 worn underneath the backpack.

In a non-limiting exemplary embodiment, the body 11 is recyclable.

In a non-limiting exemplary embodiment, the body 11 is reusable.

In a non-limiting exemplary embodiment, the body 11 is waterproof.

In a non-limiting exemplary embodiment, the body 11 is windproof

In a non-limiting exemplary embodiment, the body 11 retains heat of the wearer when worn by the wearer.

In a non-limiting exemplary embodiment, wherein the body 11 is suitably sized and shaped so there is no need to clutch a blanket (not shown) around the wearer.

While non-limiting exemplary embodiment(s) has/have been described with respect to certain specific embodiment(s), it will be appreciated that many modifications and changes may be made by those of ordinary skill in the relevant art(s) without departing from the true spirit and scope of the present disclosure. It is intended, therefore, by the appended claims to cover all such modifications and changes that fall within the true spirit and scope of the present disclosure. In particular, with respect to the above description, it is to be realized that the optimum dimensional relationships for the parts of the non-limiting exemplary embodiment(s) may include variations in size, materials, shape, form, function and manner of operation.

The Abstract of the Disclosure is provided to comply with 37 C.F.R. § 1.72(b) and is submitted with the understanding that it will not be used to interpret or limit the scope or meaning of the claims. In addition, in the above Detailed Description, various features may have been grouped together or described in a single embodiment for the purpose of streamlining the disclosure. This disclosure is not to be interpreted as reflecting an intention that the claimed embodiment(s) require more features than are expressly recited in each claim. Rather, as the following claims reflect, inventive subject matter may be directed to less than all of the features of any of the disclosed non-limiting exemplary embodiment(s). Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiment(s) which fall within the true spirit and scope of the present disclosure. Thus, to the maximum extent allowed by law, the scope of the present disclosure is to be determined by the broadest permissible interpretation of the following claims and their equivalents and shall not be restricted or limited by the above detailed description.

What is claimed as new and what is desired to secure by Letters Patent of the United States is:

1. A combination poncho and emergency blanket comprising: a body including
a flexible sheet having a first outer layer and a second outer layer attached to said first outer layer, wherein said first outer layer is a front face of said body and said second outer layer is a rear face of said body;
a first aperture located at a top first side of said body and configured to receive a user head therethrough;
a second aperture located at a lateral second side of said body and configured to receive a user first arm therethrough;
a third aperture located at a lateral third side of said body and configured to receive a user second arm therethrough; and
a hood statically connected to said first aperture;
wherein said first outer layer includes a biaxially oriented polyethylene terephthalate resin;
wherein said second outer layer includes an aluminized biaxially oriented polyethylene terephthalate resin;
wherein said first outer layer and said second outer layer have a combined cross-sectional thickness of 24 microns.

2. The combination poncho and emergency blanket of claim 1, wherein said biaxially oriented polyethylene terephthalate resin is transparent.

3. The combination poncho and emergency blanket of claim 1, wherein biaxially oriented polyethylene terephthalate resin is opaque and contains a color pigment.

4. The combination poncho and emergency blanket of claim 3, wherein said aluminized biaxially oriented polyethylene terephthalate resin has a reflective metallic surface.

5. The combination poncho and emergency blanket of claim 4, wherein each of said biaxially oriented polyethylene terephthalate resin and said aluminized biaxially oriented polyethylene terephthalate resin has a respective thickness equal to 12 microns.

6. The combination poncho and emergency blanket of claim 5, wherein said biaxially oriented polyethylene terephthalate resin is directly and thermally bonded to said aluminized biaxially oriented polyethylene terephthalate resin.

7. The combination poncho and emergency blanket of claim 6, wherein each of said first outer layer and said second outer layer has a uniform cross-sectional thickness throughout an entire surface area thereof, respectively.

8. The combination poncho and emergency blanket of claim 7, wherein said second aperture is coextensively shaped as said third aperture.

9. The combination poncho and emergency blanket of claim 8, wherein said first aperture is medially and equidistantly disposed between said second aperture and said third aperture.

10. A combination poncho and emergency blanket comprising: a body consisting of
a flexible sheet consisting of a first outer layer and a second outer layer directly attached to said first outer layer, wherein said first outer layer is a front face of said body and said second outer layer is a rear face of said body;
a first aperture located at a top first side of said body and configured to receive a user head therethrough;
a second aperture located at a lateral second side of said body and configured to receive a user first arm therethrough;
a third aperture located at a lateral third side of said body and configured to receive a user second arm therethrough; and
a hood statically connected to said first aperture;
wherein said first outer layer includes a biaxially oriented polyethylene terephthalate resin;
wherein said second outer layer includes an aluminized biaxially oriented polyethylene terephthalate resin;
wherein said first outer layer and said second outer layer have a combined cross-sectional thickness of 24 microns.

11. The combination poncho and emergency blanket of claim 10, wherein said biaxially oriented polyethylene terephthalate resin is transparent.

12. The combination poncho and emergency blanket of claim 10, wherein biaxially oriented polyethylene terephthalate resin is opaque and contains a color pigment.

13. The combination poncho and emergency blanket of claim 12, wherein said aluminized biaxially oriented polyethylene terephthalate resin has a reflective metallic surface.

14. The combination poncho and emergency blanket of claim 13, wherein each of said biaxially oriented polyethylene terephthalate resin and said aluminized biaxially oriented polyethylene terephthalate resin has a respective thickness equal to 12 microns.

15. The combination poncho and emergency blanket of claim 14, wherein said biaxially oriented polyethylene terephthalate resin is directly and thermally bonded to said aluminized biaxially oriented polyethylene terephthalate resin.

16. The combination poncho and emergency blanket of claim 15, wherein each of said first outer layer and said second outer layer has a uniform cross-sectional thickness throughout an entire surface area thereof, respectively.

17. The combination poncho and emergency blanket of claim 16, wherein said second aperture is coextensively shaped as said third aperture.

18. The combination poncho and emergency blanket of claim 17, wherein said first aperture is medially and equidistantly disposed between said second aperture and said third aperture.

19. A method of utilizing a combination poncho and emergency blanket, said method comprising the steps of:
providing a body consisting of: a flexible sheet consisting of a first outer layer and a second outer layer directly attached to said first outer layer, wherein said first outer layer is a front face of said body and said second outer layer is a rear face of said body, a first aperture located at a top first side of said body and configured to receive a user head therethrough, a second aperture located at a lateral second side of said body and configured to receive a user first arm therethrough, a third aperture located at a lateral third side of said body and configured to receive a user second arm therethrough, and a hood statically connected to said first aperture; wherein said first outer layer includes a biaxially oriented polyethylene terephthalate resin; wherein said second outer layer includes an aluminized biaxially oriented polyethylene terephthalate resin; wherein said first outer layer and said second outer layer have a combined cross-sectional thickness of 24 microns; and
a user wearing said body over an upper region of the user.
